(19) United States
(12) Patent Application Publication
(10) Pub. No.: US 2025/0272736 A1
(43) Pub. Date: Aug. 28, 2025

(54) SYSTEM AND METHOD OF DYNAMICALLY CUSTOMIZABLE INTERFACE FOR PACKAGED GOODS

(71) Applicant: 2524331 Alberta Ltd., Calgary (CA)

(72) Inventor: Deress ASGHEDOM, Calgary (CA)

(21) Appl. No.: 19/208,486

(22) Filed: May 14, 2025

Related U.S. Application Data
(63) Continuation of application No. PCT/CA2025/050071, filed on Jan. 17, 2025.
(60) Provisional application No. 63/622,976, filed on Jan. 19, 2024.

(51) Int. Cl. G06Q 30/0601; G06Q 30/0282

(52) U.S. Cl. CPC G06Q 30/0627; G06Q 30/0282; G06Q 30/0643

(57) ABSTRACT

Herein is disclosed a method of displaying a dynamically customized user interface for a plurality of products on a computing device, the method comprising: receiving product data; receiving search parameters; generating an initial product ranking; generating an initial user interface king; displaying the initial user interface on the computing device; receiving an attribute ranking; generating a personalized product ranking based on the product attributes, the product search parameters, and the attribute ranking; generating a personalized user interface; and displaying the personalized user interface on the computing device.

### CROSS-REFERENCE TO RELATED APPLICATIONS

This application is a continuation of International Patent Application No. PCT/CA2025/050071 filed 17 Jan. 2025, which in turn claims priority from application No. 63/622,976, filed 19 Jan. 2024, each of which is incorporated by reference herein in its entirety. For purposes of the United States, this application claims the benefit under 35 U.S.C. § 119 of application No. 63/622,976, filed 19 Jan. 2024, and entitled SYSTEM AND METHOD OF DYNAMICALLY CUSTOMIZABLE INTERFACE FOR PACKAGED GOODS which is hereby incorporated herein by reference for all purposes.

### TECHNICAL FIELD

The specification relates to dynamically customizable interfaces generally, and in particular, to a system and method of dynamically customizable interfaces for packaged goods.

### BACKGROUND

Personal electronic devices such as laptops, smartphones and tables are now ubiquitous. These devices are usually in the form of a computing device of appropriate form factor and include hardware and software components that interact to provide interfaces allowing users to input data and receive output.

Input interfaces are usually in the form of keypads, keyboards, mouse inputs and touch screens. Other peripheral devices may also be used to enter data such as joysticks and wired or wireless input devices that connect to the electronic device.

Conventional user experiences with a handheld computing device are often generic, and does not take into account a particular user's specific needs. Conventional systems are thus designed with determinations that are often statistically based, design choices, best guesses, or assumptions regarding a typical use case. Features that are determined to be popular by the user interface designers inform the design such that the most commonly used user interface elements are often provided so that they are most easily accessible whereas rarely used functions often require a sequence of clicks or button presses to arrive at.

In addition, conventional devices provide interfaces that are mostly static in the sense that they do not learn from and adapt to a user's interactions by themselves but instead either remain the same with every use or require knowledge of the configuration scheme for the user interface so that future user interactions are manually configured to a different set of interactions where such configuration is possible.

Moreover, very limited if any use is made of interfaces other than traditional means of providing input such as typing on keypads and touches on touch screens. Although, the basic tenets of user experience design for interacting with electronic devices are known, improvements in one or more of efficiency, ease of use, adaptability are desired.

There is a general desire for an improved system of method for providing an interface for packaged goods, and in particular, a dynamically customizable interface for packaged goods.

The foregoing examples of the related art and limitations related thereto are intended to be illustrative and not exclusive. Other limitations of the related art will become apparent to those of skill in the art upon a reading of the specification and a study of the drawings.

### SUMMARY

Further aspects and example embodiments are illustrated in the accompanying drawings and/or described in the following description.

One aspect of the invention provides a system for providing an adaptive user interface to a user, the system comprising: a computing device comprising a processor, a memory and a scanner, the memory storing instructions to implement application software comprising: a live-scanner module for receiving from the scanner, scanning data of a packaging label for a product and matching the label to one of a plurality of products stored in the memory; a menu-view module for accessing geographic information about a store providing at least a subset of the plurality of products; a memory-bank module for recording and retrieving a user's interaction with the application software to provide said adaptive user interface; and a magic-match module for product discovery, enabling the software to provide new products selected from said plurality of products matching interests of the user; an artificial intelligence (AI) engine for use by one or more of the modules; and a local database storing data for use by the AI engine and the processor.

In accordance with one aspect of the present disclosure, there is provided a system for providing an adaptive user interface to a user, the system comprising: a computing device comprising a processor, a memory and a scanner, the memory storing instructions to implement application software comprising: a live-scanner module for receiving from the scanner, scanning data of a packaging label for a product and matching the label to one of a plurality of products stored in the memory; a menu-view module for accessing geographic information about a store providing at least a subset of the plurality of products; a memory-bank module for recording and retrieving a user's interaction with the application software to provide said adaptive user interface; and a magic-match module for product discovery, enabling the software to provide new products selected from said plurality of products matching interests of the user; an artificial intelligence (AI) engine for use by one or more of the modules; and a local database storing data for use by the AI engine and the processor.

Some embodiments of the present invention provide a method of displaying a dynamically customized user interface for a plurality of products on a user device, the method comprising: receiving product data comprising a plurality of product descriptions and a plurality of product attributes, wherein each of the product attributes is associated with one of the product descriptions and has an attribute type of a plurality of attribute types and an attribute value; receiving search parameters via an interface of the user device, wherein each of the search parameters corresponds one of the attribute types and has a search value; generating an initial product ranking of one or more of the product descriptions based on the product attributes and the product search parameters; generating an initial user interface comprising the initial product ranking; displaying the initial user interface on the user device; receiving an attribute ranking via the interface of the user device, wherein the attribute ranking comprises a ranked list of at least two of the plurality of attribute types; generating a personalized product ranking of one or more of the product descriptions based on the product attributes, the product search parameters, and the attribute ranking; generating a personalized user interface comprising the personalized product ranking; and displaying the personalized user interface on the user device.

In some embodiments, the method further comprises receiving a personalized product attribute via the interface of the user device, wherein the personalized product attribute is associated with a one of the product descriptions, and wherein generating the personalized product ranking comprises generating the personalized product ranking based on the personalized product attribute. The personalized product attribute may have an attribute value and an attribute type equal to an attribute type of a one of the product attributes also associated with the one of the product descriptions, and the method may further comprise replacing the attribute value of the one of the product attributes with the attribute value of the personalized product attribute before generating the personalized product ranking.

Other technical advantages may become readily apparent to one of ordinary skill in the art after review of the following figures and description.

In addition to the exemplary aspects and embodiments described above, further aspects and embodiments will become apparent by reference to the drawings and by study of the following detailed descriptions.

### BRIEF DESCRIPTION OF THE DRAWINGS

The accompanying drawings illustrate non-limiting example embodiments of the invention.

FIG. 1 is a schematic block diagram representation of a system for providing an adaptive user interface that is dynamically and automatically customized for consumers or users of packaged goods, according one embodiment, which is an example of the present disclosure.

FIG. 2 a schematic block diagram of several hardware and data forming part of a server computer in FIG. 1.

FIG. 3 a schematic block diagram of several hardware blocks of the mobile device of FIG. 1.

FIG. 4 is a simplified block diagram of an exemplary embodiment of a client device software in the form of an app, which executes on the mobile device of FIG. 1.

FIG. 5 is a block diagram of a method for displaying a dynamically customized user interface for a plurality of products on a computing device.

Unless otherwise specifically noted, articles depicted in the drawings are not necessarily drawn to scale.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

For clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although embodiments are illustrated in the figures and described below, the principles of the present disclosure may be implemented using any number of techniques, whether currently known or not. The present disclosure should in no way be limited to the implementations and techniques illustrated in the drawings and described in this disclosure.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or as a non-limiting example, and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Embodiments of the present disclosure include a system and method of providing a dynamically customizable interface for packaged goods in the form of a handheld device running custom mobile software which may interact with a server.

A system, which is representative of an embodiment of the present disclosure, may include a mobile application which is used to provide a highly customized dynamic interface and experience to consumers of packaged goods. Accordingly, one embodiment of a system includes a mobile application (or “app”) which is used to provide a highly customized, adaptive, dynamic interface and experience to consumers of packaged goods.

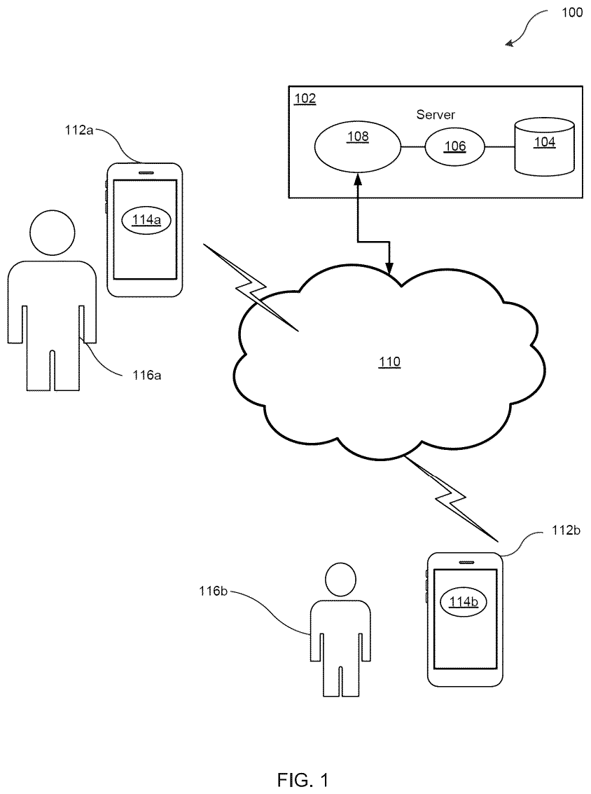

FIG. 1 is a schematic block diagram representation of system 100 that provides an adaptive user interface that is dynamically and automatically customized for consumers or users of packaged goods. As shown in FIG. 1, a simplified block diagram of system 100 includes server 102 that hosts an application platform, in data communication with one or more digital electronic or computing devices 112a, 112b (individually and collectively, devices 112, or user devices 112) used respectively by users 116a, 116b (individually and collectively, users 116) via network 110.

In this embodiment, server 102 includes data storage 104, app server or web-server software 108, and application logic 106 adapted for facilitating communication between data storage 104 and web-server software 108. Web-server software 108 is adapted for communicating with client-side applications 114a, 114b (individually and collectively, application 114 or “app 114”) running on devices 112a, 112b respectively. In one embodiment, app 114 may be a mobile application and server 102 may be a mobile server hosting a platform.

In other embodiments, client-side software applications are not limited to apps (such as app 114) running on smartphones but may also include other types of applications that can be run on client devices including wearable devices such as smart watches and heads up displays, mobile handheld devices, tablets, personal digital assistants (PDAs), laptops, desktop computers, workstations, point of sale (PoS) terminals, and the like, that are in data communication with corresponding servers.

Web-server software 108 can be any suitable web-server software that runs on a server or the cloud. Client applications, apps, or web browsers on devices 112 may communicate with and access data on server 102 through network 110. Suitable web-server software applications include, but are not limited to, the Apache HTTP Server and the Internet Information Server (IIS). In other embodiments, the server-side computing system can be a system comprising a network of computers (e.g. database server computer, processing engine server computer, web-server computer), or a cloud service that uses a large network of server computers (e.g. database server computers, processing engine server computers, web-server computers), the server computers collectively hosting multiple instances of processing engines, databases and web-servers.

Each of computing devices 112 accesses server 102 through application 114 such as a mobile app, desktop application or web application running thereon.

App 114, in the depicted embodiment, is a custom mobile application or app that is designed to provide a customized user experience to a user of a packaged product by utilizing a record or history of the user's individual interactions and may apply artificial intelligence (AI) to enable delivery of a highly personalized experience to the user.

The personalized experience may include providing a customized product description based on the user's previous encounters with a product, and/or customized search results based on the user's previous encounter with one or more products. The app 114 dynamically adjusts in real time on user's device 112 to reduce delays and eliminate unnecessary user interface elements or entire screens, or touch or keypad inputs.

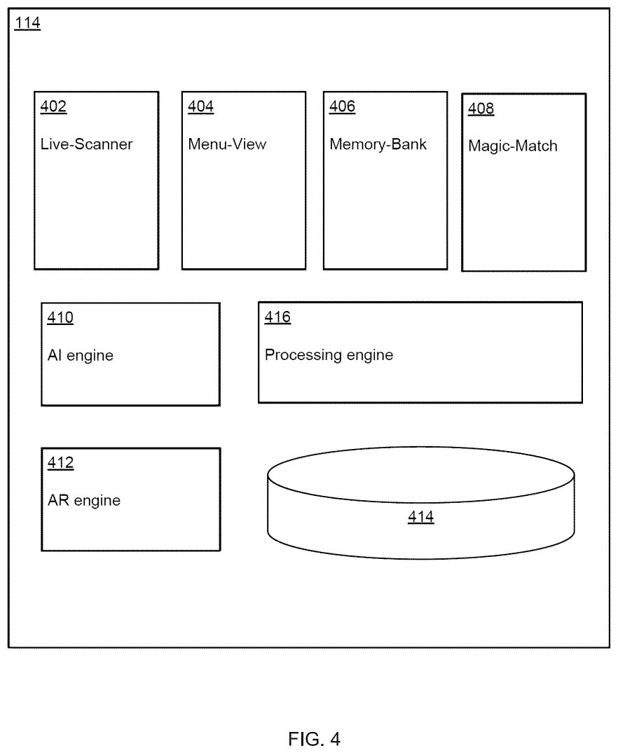

As will be detailed later with reference to FIG. 4, app 114 implements one or more of the following dynamic personalization modules: a Live-Scanner module, a Menu-View module, a Memory-Bank module, and a Magic-Match module.

The Live-Scanner module may use machine learning (ML) via an artificial intelligence (AI) engine, as well as one or more of: optical character recognition (OCR) and barcode scanning to identify a product, and to match the identified product to a record in a database. Information about the identified product may then be superimposed onto product details on-screen by app 114, for example by using augmented reality (AR).

The Menu-View module allows for selection of a store either from a predetermined list or when the user is physically proximate to a store, using geolocation.

The Memory-Bank module is a store or log of user experiences and reviews and may be used as an input for filtering and customizing future user interactions of the app 114 with the user 116.

The Magic-Match module allows for product discovery and includes features such as listing store locations and products matching a user's preference profile.

In FIG. 1, processing engine 106 is shown executing on server 102 to implement processing engine rules for system 100. As contemplated in this embodiment, processing engine 106 can be implemented as software components, services, server software, or other software components forming part of processing engine 106. Processing engine 106 encodes specific rules for one or more of the Live-Scanner module, the Menu-View module, the Memory-Bank module, and the Magic-Match module, using input data including for example camera input, received from devices 112 or retrieved from data storage 104.

Data storage 104 provides storage for persistent data. Persistent data includes, but is not limited to, data related to user accounts, digital objects such as avatars associated with user accounts, location or position data associated with avatars, state information related to the digital canvas, relationships among users and the like.

Persistent data is often required for applications that reuse saved data across multiple sessions or invocations. As contemplated in this embodiment, data storage 104 may include databases or cloud storage systems or combination of both. Databases can include relational database management software (RDBMS) or non-relational (NoSQL) databases.

Suitable RDBMS include, but are not limited to, the Oracle® server, the Microsoft SQL Server database, the DB2 server, MySQL server, and any alternative type of database such as an object-oriented database server software. The data storage 104 may be an encrypted storage and the encryption may use any method known in the art. In other embodiments, the database on the server-side computing system is not an RDBMS. In other embodiments, the database is not encrypted.

In other embodiments, server 102 has separate database server hardware to host data storage 104. In other embodiments, the system has a separate application server computer for the purpose of providing additional resources in terms of processors, memory capacity, and storage capacity to improve the performance of the system. In other embodiments, the system further comprises a business logic server that is external to server 102, the business logic server for hosting an application logic (e.g. application logic 106). Other computing devices suitable for communication with server 102 or as devices 112 include, but are not limited to, server class computers, workstations, personal computers, wearable devices, smartphones, and any other suitable computing device.

In this embodiment, network 110 is the Internet. In other embodiments, the network can be any other suitable network including, but not limited to, a cellular data network, Wi-Fi™, Bluetooth™, WiMax™, IEEE 802.16 (WirelessMAN), and any suitable alternative thereof. The suitable data communications interface contemplated in this embodiment between devices 112 and network 110 is wireless. In other embodiments, wired data communication links may be used. In wireless embodiments, the interface can take the form of an antenna, a Bluetooth™ transceiver, a Wi-Fi™ adapter, or a combination thereof.

As contemplated in this embodiment, device 112 is a smartphone, a tablet device, personal digital assistant (PDA) or another handheld or wearable electronic device, for example a smart watch or heads up display. Non-limiting examples of such handheld devices include smartphones (e.g. iPhone™, Blackberry™, Android™ phone), cellular telephones, media players, laptops, tablets, AR/VR (augmented-reality/virtual-reality) devices or other computing devices which may combine one or more aspects or functions of the foregoing devices. The client application software may be a game software or a social software.

In alternate embodiments, device 112 may also be a desktop or laptop computer, such as a personal computer (PC) or laptop running Windows® or Linux, MacBook®, MacBook Pro®, MacBook Air®, iMac®, Mac® Mini, or Mac Pro® from Apple Inc. In other embodiments, the devices can be any other suitable electronic devices having a suitable display and a data communications interface to network 110. One or more of devices 112 are used by the consumers to participate in electronic commerce.

### Server Hardware

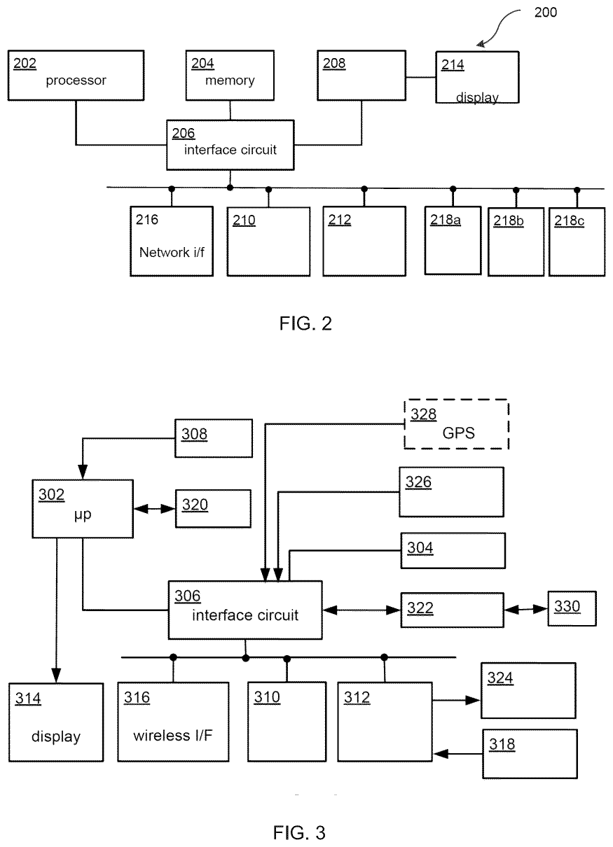

FIG. 2, depicts a simplified block diagram of computing device hardware 200. Hardware 200 comprises a processor 202 such as, but not limited to, a microprocessor, central processing unit (CPU), a digital signal processor (DSP) or the like; a memory medium 204, and interface circuit 206 adapted to provide a means of communication between processor 202 and memory medium 204 and video interface 208 which may interconnect to a display 214.

Interface circuit 206 also interconnects input and output (I/O) components such as, network adapter 216, and storage medium 210. In the depicted embodiment, interface circuit 206 additionally interconnects printer 212 and one or more additional peripherals 218a to 218c (individually and collectively, peripherals 218). Suitable peripherals 218 include, but are not limited to, a keyboard, a camera, a scanner, a touch panel, a joystick, an electronic mouse, touch screen, track-pad, and other input or pointing devices, and any combination thereof. In other embodiments, the interface circuit does not interconnect a printer. In other embodiments, the interface circuit does not interconnect any peripherals.

Memory medium 204 may be in the form of volatile memory or a combination of volatile and non-volatile memory, including, but not limited to, dynamic or static random access memory (RAM), read-only memory (ROM), flash memory, solid state memory and the like.

Interface circuit 206 includes a system bus for coupling any of the various computer components 210, 212, 214, 216, 218 to the processor 202. Suitable interface circuits include, but are not limited to, Industry Standard Architecture (ISA), Micro Channel Architecture (MCA), Extended Industry Standard Architecture (EISA), VESA Local Bus (VLB), Peripheral Component Interconnect (PCI), Peripheral Component Interconnect Extended (PCI-X), Accelerated Graphics Port (AGP), Peripheral Component Interconnect Express (PCIe).

Storage medium 210 can be any suitable storage medium including, but not limited to, cloud storage, a hard disk drive (HDD), a solid-state drive (SSD), EEPROM, CD-ROM, DVD, and any other suitable data storage element or medium accessible by processor 202. Storage medium 210 is readable by processor 202. In some embodiments, reading storage medium 210 with processor 202 may comprise processor 202 communicating with storage medium 210 over a communication network, for example the internet.

Display 214 can be any suitable display including, but not limited to, monitor, a television set, a touch screen, and the like.

Network adapter 216 in server 102 facilitates wired or wireless connections to an Ethernet, Wi-Fi™, Bluetooth™, cellular network or other suitable network, thereby enabling connection to shared or remote drives, one or more networked computer resources, other networked devices, I/O peripherals and the like. Devices 112 also contain complementary network adapters therein for connecting with a suitable network, and are further equipped with browser or other thin-client or rich-client software. As contemplated in this embodiment, network adapter 216 comprises a wireless network interface card that allows communication with other computers through a data network such as network 110. In other embodiments, the network adapter does not comprise a wireless network interface card. In other embodiments, the network adapter communicates with the network via a wired connection.

In some embodiments, the hardware architectures of computing device 112b and server 102 may be as depicted in FIG. 2.

### Client Device Hardware

, depicts a simplified block diagram of an exemplary embodiment of a client device hardware such as mobile device 112a. Device 112a comprises a processor 302 such as, but not limited to, a microprocessor, a memory 304, an input 308 such as touch surface or controllers, a battery 320, and a display 314.

Several components and processor 302 communicate with each other through an interface circuit 306. Interface circuit 306 also interconnects components including, but not limited to, a wireless network interface 316, a storage medium 310, an input-output (I/O) interface 322, a camera 326, an audio codec 312 and a tracking module 328 such as a GPS unit. Audio codec 312 in turn connects to one of more microphones 318 and one or more speakers 324. A sensor 330 and/or other components may interconnect to processor 302 via I/O interface 322.

Wireless network interface 316 includes one or more of a wireless LAN transceiver (e.g. Wi-Fi™ transceiver), an infrared transceiver, a Bluetooth™ transceiver, and a cellular telephony transceiver. I/O interface 322 may include one or more wired power and communication interfaces such as a USB port.

Input 308 may be a keypad or keyboard, a touch panel, a multi-touch panel, a gesture controller, a voice controller, or any custom controller, a touch display or multi touch display having a software keyboard or keypad displayed thereon.

FIG. 4 is a simplified block diagram of an exemplary embodiment of a client device software in the form of app 114, which executes on as mobile device 112.

App 114 is made up of processor executable instructions executing on client device 112 and includes various software components in the form of one or more of Live-Scanner module 402, Menu-View module 404, Memory-Bank module 406, and Magic-Match module 408. In addition, app 14 may include artificial intelligence (AI) engine 410 which may be a machine learning (ML) engine or a deep learning engine.

In the depicted embodiment, app 114 also includes an augmented reality (AR) engine 412, local processing engine 416 and data store 414. In some embodiments, processing may be shared between the server processing engine 106 and the local processing engine 416 while in other embodiments the processing may be carried out mostly or entirely in local data store 414, for example where data privacy concerns are not adequately addressed in a server environment.

Data store 414 in device 112 provides storage for persistent data which may include, but is not limited to, data related to user accounts, product usage history, settings, preference data, user interface element usage history, store locations, device location and associated history, and the like.

As contemplated in this embodiment, data store 414 may include databases that are suited for mobile devices and may include relational database management software (RDBMS) or non-relational (e.g., NoSQL) databases.

Suitable RDBMS include, but are not limited to SQLite, Couchbase, SQL server Compact, and the like. The data store 414 may be an encrypted or non-encrypted storage.

In operation, app 114 utilizes a record or history of such user's individual interactions and by applying artificial intelligence (AI) using AI engine 410 to enable delivery of a personalized experience to such user.

These customized experiences include product descriptions tailored to an individual user, based on the user's previous encounters with app 114. Adjustments may be carried out in real time on the user's device 112. Other aspects include reducing delays and eliminating unnecessary screens, user interface elements and touch or keypad inputs when using app 114.

As noted above, app 114 utilizes one or more of its modules, camera 326, and optical character recognition (OCR) and/or barcode scanning to identify a product and to match the product to a record in a data store 414. In some embodiments, visual identification of a product may comprise image recognition of the product in an image, for example vision recognition with a trained machine learning model. Information about the product is then superimposed onto product details on-screen using the app 114, using augmented reality (AR) engine 412.

Menu-View module 404 allows for selection of a store either from a predetermined list or when the user is physically proximate to a store-using geolocation. In some embodiments, store selection may comprise store selection through presenting a map to the user, and the user selecting a store in the map.

Memory-Bank module 406 is a store or log of user experiences and reviews, and is used as an input for filtering and customizing future user interactions of app 114 with the user.

Magic-Match module 408 is used for product discovery and may list store locations and products matching a user's preference profile.

Upon receiving a selection input for a particular store location, the app 114 displays the selected store's menu with matching products.

An example of a packaged product which is suited for highly personalized customization for which app 114 can be used is a product having one or more bioactive ingredients, for example: a food, a drink, a medicinal product, and the like. A product containing one or more bioactive ingredients may be referred to as a bioactive product. Bioactive products may be experienced different between users, and as such, a particular user's experience with such a product may vary from another user's experience with the product.

In one embodiment, all relevant data is locally stored on a mobile device 112 and retrieved as needed. This kind of data storage model permits stringent privacy requirements to be met and reduces latency. In such embodiments, a given user may be identified with a unique alphanumeric string, so that no personal information is associated with the user. The user may then store part of all of their data on the sever, without having said data associated with their personal identity.

A machine learning module in the form of AI engine 410 is implemented on the device 112 itself.

Other/future embodiments may include reporting packages on the cloud.

In some embodiments, app 114 includes a database for use with optical character recognition (OCR) and a database for pattern recognition. Other features include web onboarding, in which data obtained is propagated to the mobile app 114.

The system 100 may also require product providers, for example licensed producers of bioactive products or ingredients, to submit packaged product imaging. App 114 may include “onset and duration” graphs for bioactive products and content of the bioactive products. An onset and duration graphs may provide a particular user's experience, or an average of a group of users' experiences, of the onset and duration of an effect of a bioactive ingredient. For example, a bioactive ingredient for pain relief may have a given onset and duration of the pain relief effect.

In addition, a “consumption & application” slider in the app may provide users with real-time information about the content of a bioactive product (e.g., type and amount of bioactive ingredient per product dose). These features may capture the onset of an effect of a bioactive ingredient, and a specification of the bioactive ingredient about to be consumed. Providing such information may provide transparency into the contents and expected effect of a bioactive product.

The complexity of certain bioactive products presents a significant challenge, as certain bioactive products and ingredients may affect individuals in diverse and varied ways. For many such products, there is no universal solution that caters to every consumer's needs.

Embodiments of the present invention thus customize the user's experience and record their individual interactions, enabling delivery of a personalized product description based on their previous encounters with the same packaged item. Notably, these interactions occur in real time on the user's device 112, minimizing delays and eliminating the necessity for multiple screen touches.

Live-Scanner module 402 uses machine learning technology embodied in AI engine 410 to receive a scan of the product packaging, identifying patterns, and utilize optical character recognition to match the product name with an extensive database in data store 414. This enables retrieving additional information from a backend database that may be in the cloud or in data store 414.

Augmented reality via AR engine 412 is then employed to superimpose product details on the screen. Furthermore, system allows users to scan multiple barcode standards, including GS1 Datamatrix, UPC-A, GS1 databar expanded, and GS1 databar expanded stacked, providing additional failsafe matching capabilities.

These functions empower users to quickly access information about a product that is typically unavailable on the packaging itself. In cases where relevant data can be obtained, details are provided by app 114 on where the product can be purchased, along with pricing information.

Unlike many conventional applications that utilize third-party services to detect characters and words using camera scanners and cloud-based databases, app 114 is able to successfully match words with products from a proprietary database in data store 414.

In one embodiment, an algorithm forming part of app 114 takes the detected words and generates the most probable combinations, allowing comparison of these combinations with the products in database or data store 414. This innovative approach enhances the accuracy and efficiency of the product matching process to identify and present uniquely suitable selections for a particular user.

Menu-View module 404 offers users 116 two convenient methods to access or explore a specific store's menu. The first option involves: selecting the store from a provided list, while the second option allows them to or physically enter a desired store utilizing the features of Menu-View module 404. In some embodiments, selecting a store from a provided list may comprise selecting a store from a provided list presented to the user in a graphical map.

The first option allows users to select a store from a list of available options on app 114. This enables users 116 to quickly access the menu of their desired store without physically being present at the location. By selecting a store, users 116 gain instant access to its the store's menu, providing a seamless browsing experience as illustrated in FIG. 22.

The second option involves physically entering the store and utilizing the Menu-View module 404. Here geolocation is used. Once inside the store, users can access the menu directly through the application or app 114. This feature utilizes scanning via camera 326 or via other scanning means to provide users 116 with a visual representation of the menu, allowing them to easily browse through available products.

Regardless of the chosen method, the features enabled by Menu-View module 404 take into consideration, the user's established a product preference, user profile, or applied specific product filters. This ensures that the presented menu will automatically prioritize products that align with the individual user's set preferences or filters. Additionally, by tailoring the menu will display their preferences, users can quickly find products that are currently available at the selected store location that match their specific needs and interests.

Furthermore, the menu displays real-time information about product availability at the selected store location. Users 112 can view which products are currently in stock, enabling them to make informed decisions and avoid negative experiences.

Menu-View module 404 provides users with convenient and personalized access to a specific store's menu. By offering multiple access methods, prioritizing user preferences, and providing real-time availability information, app 114 enhances the user experience and streamline the process of exploring and selecting products from a store's menu.

Memory-Bank module 406 enables users to document their personal experiences with products. FIGS. 9-16 user interface illustrations related to features enabled by Memory-Bank module 406. These logs in Memory-Bank module 406 include essential data points such as onset and duration of effects, which are graphically represented to illustrate when the effects occurred and how long they lasted. Users have the ability to augment or modify the effects they experienced from product usage. They can also override or add information about common usage recommendations. Additional attributes like flavors can be logged as well. Furthermore, users can leave product reviews.

Once the experience of a user has been logged in Memory-Bank module 406, the next time the user engages with the same product, the product data presented will be based on their own recorded experiences. Users can choose to make their feedback public, in which case their product reviews will be accessible alongside the product information. Alternatively, if they opt for privacy, their reviews will only be visible to them when they view the respective product card.

### On-Set & Duration:

The “On-Set & Duration” is a feature designed to enhance the user experience within app 114. With this feature, users can conveniently log and track their individual experiences with the product in Memory-Bank module 406.

By recording the “On-Set” time, users can precisely capture the exact moment when they begin interacting with the product. This allows for accurate tracking and analysis of their experiences over time.

Additionally, users can specify the “Duration” of each interaction, providing valuable insights into the length of time they spend using the product. This information is stored in Memory-Bank module 406, creating a comprehensive record of past interactions.

One of the key benefits of this feature is its ability to provide users with a historical overview of their past experiences. By accessing data via the Memory-Bank module 406 thought app 114, users can review their previous interactions and gain a deeper understanding of their usage patterns, preferences, and trends.

“On-Set & Duration” data enables users to compare their experiences with the aggregated data of all their interactions. By viewing the average duration across their sessions, users can identify patterns and trends that may offer valuable insights for future experiences. Users may thus get a clearer understanding of their individual use cases, identify areas for improvement, and make informed decisions based on their past experiences. FIG. 18 depicts an example illustration of the graph.

### Consumption & Application Sliders:

The “Consumption/Application” feature in app 114 provides users with real-time information about the bioactive content of edible and topical products. This feature is designed to empower users with crucial insights before they consume or apply any product.

With this feature, users 112 can easily access the bioactive content of the specific product they are about to consume or apply. By displaying this information in real time, users can make informed decisions about their usage, ensuring they have a clear understanding of what they are about to interact with.

A primary goal of this feature is to help users safeguard against possible overconsumption of a bioactive ingredient, for example in instances where an individual may be otherwise unknowingly consuming products with the same bioactive ingredient. By knowing the bioactive ingredient content beforehand, a user can accurately gauge the potency, or combined potency, of a bioactive ingredient, and adjust their consumption or application accordingly. This promotes responsible usage and minimizes the risk of consuming or applying more of a bioactive ingredient than desired.

Moreover, the “Consumption/Application” feature may assist users in managing alternative consumption methodologies, for example consuming an amount of a bioactive ingredient smaller than that typically consumed to achieve a desired effect of the bioactive ingredient, sometimes referred to as “microdosing”. Microdosing may involve taking a small, controlled amount of a bioactive ingredient to achieve a specific effect while minimizing one or more unwanted side effects. By providing real-time bioactive content information, users can effectively manage their microdosing routines, ensuring they stay within a desired dosage range for the bioactive ingredient.

This feature aims to provide transparency and empower users to make well-informed decisions about their consumption or application of a bioactive ingredient. By having access to accurate and up-to-date information, users can confidently navigate their experiences with edible and topical transparency products, optimizing their usage and achieving their desired outcomes.

### Magic-Match:

Magic-Match provides a convenient product discovery feature, enabling users to explore new items that align with their preferences without the need for additional searching and exploration. With a simple one-button interaction, users can effortlessly discover new packaged products that match their peculiar interests.

Upon activating Magic-Match (MM) via a button, the app 114 presents products that correspond to the user's preference settings within their activated user/product profile. There are various scenarios in which the user can click on the Magic-Match button.

If the user is located outside a store and clicks the MM button, a map displaying store locations will appear, accompanied by a list of three or four products that match the user's profile. By selecting a product card, the user can access comprehensive information about the item, including where it can be purchased. Clicking on a store location on the map will lead the user to the store's menu, with the matching products highlighted.

When the user activates the Magic-Match module 408 while inside a store, the user will be presented with several (three or four) product cards that match their preferences. Selecting a specific card will provide additional product details for further exploration.

### Advantages

Advantageously, embodiments disclosed utilize AI to tailor the experience of a user of the app to automatically adapt and cater to the needs and preferences of the user. In addition several advantageous features such as the profile allow safer consumption of substances whose dosage needs to be monitored and customized to individual users.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### Dynamically Customized User Interface

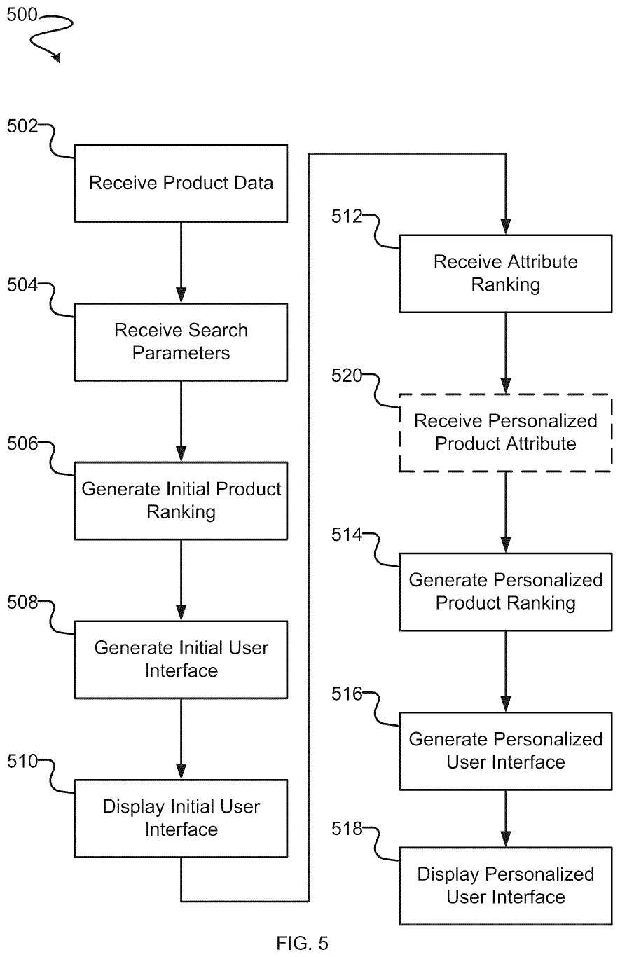

FIG. 5 is a block diagram of method 500 for displaying a dynamically customized user interface for a plurality of products on a user device. Method 500 comprises:
step 502: receiving product data comprising a plurality of product descriptions and a plurality of product attributes, wherein each of the product attributes is associated with one of the product descriptions and has an attribute type of a plurality of attribute types and an attribute value;
step 504: receiving search parameters via an interface of the user device, wherein each of the search parameters corresponds one of the attribute types and has a search value;
step 506: generating an initial product ranking of one or more of the product descriptions based on the product attributes and the product search parameters;
step 508: generating an initial user interface comprising the initial product ranking;
step 510: displaying the initial user interface on the user device;
step 512: receiving an attribute ranking via the interface of the user device, wherein the attribute ranking comprises a ranked list of at least two of the plurality of attribute types;
step 514: generating a personalized product ranking of one or more of the product descriptions based on the product attributes, the product search parameters, and the attribute ranking;
step 516: generating a personalized user interface comprising the personalized product ranking; and
step 518: displaying the personalized user interface on the user device.

In one or more embodiments of method 500:
method 500 further comprises: step 520, receiving a personalized product attribute via the interface of the user device, wherein the personalized product attribute is associated with a one of the product descriptions; and wherein step 514, generating the personalized product ranking, comprises generating the personalized product ranking based on the personalized product attribute;
method 500 further comprises: step 520, receiving a personalized product attribute via the interface of the user device, wherein the personalized product attribute is associated with a one of the product descriptions and has an attribute value and an attribute type equal to an attribute type of a one of the product attributes also associated with the one of the product descriptions; and replacing the attribute value of the one of the product attributes with the attribute value of the personalized product attribute before step 514, generating the personalized product ranking;
the product descriptions comprise a first product description and a second product description; the product attributes comprise a first set of product attributes associated with the first product description, and a second set of product attributes associated with the second product description, wherein the first set of product attributes and the second set of product attributes each comprise a plurality of common product attributes with corresponding attribute types; the search parameters correspond to the attribute types of the common product attributes; the attribute ranking comprises a ranking of the common product attributes; and step 514, generating the personalized product ranking, comprises generating a product-attribute score for each of the common product attributes for each of the first and second product descriptions, scaling each product-attribute score by the rank of the associated common product attribute within the attribute ranking, and generating the personalized product ranking based on each scaled product-attribute score;
the attribute types comprise a mandatory attribute type and the search parameters comprise a mandatory search parameter corresponding to the mandatory attribute type, and the personalized product ranking comprises only product descriptions with an associated product attribute having an attribute type equal to the mandatory attribute type and an attribute value meeting the search value of the mandatory search parameter;
the attribute types is either a mandatory attribute type or an optional attribute type;
each of the attribute types is one of: a binary attribute, and the associated attribute value is either “true” or “false”; a range attribute, and the associated attribute value is any value within a range; an integer attribute, and the associated attribute value is any integer between a minimum value and a maximum value; a single-member attribute, and the associated attribute value is one of a set of two or more members; and a multi-member attribute, and the associated attribute value is one or more of a set of two or more members;
step 514, generating the personalized product ranking, comprises one or more of: for a product attribute with the range attribute type, scaling a first product-attribute score higher than a second product-attribute score, wherein a first distance between the first attribute value and the search value is less than a second distance between the second attribute value and the search value; for a product attribute with the integer attribute type, scaling a first product-attribute score higher than a second product-attribute score, wherein a first distance between the first attribute value and the search value is less than a second distance between the second attribute value and the search value; and for a product attribute with the multi-member attribute type, scaling a first product-attribute score higher than a second product-attribute score, wherein the first attribute value has more members in common with the search value than the second attribute value;
method 500 further comprises: receiving user location data via a location module of the user device, and step 514, generating the personalized product ranking, comprises generating the personalized product ranking based on the user location data;
the product attributes comprise product location data, and step 514, generating the personalized product ranking, comprises generating the personalized product ranking based on the product location data;
the product attributes comprise customer review data, and step 514, generating the personalized product ranking, comprises: receiving customer profile data via the interface of the user device; and generating the personalized product ranking based on the customer review data and the customer profile data;
method 500 further comprises: receiving a personalized product attribute via the interface of the user device, wherein the personalized product attribute is associated with a one of the product descriptions; and wherein the product attributes comprise customer review data, and step 514, generating the personalized product ranking, comprises generating the personalized product ranking based on the personalized product attribute and the customer review data;
generating the personalized product ranking based on the personalized product attribute and the customer review data comprises excluding the one of the product descriptions from the personalized product ranking;
generating the personalized product ranking based on the personalized product attribute and the customer review data comprises excluding a second of the product descriptions from the personalized product ranking, wherein a product attribute associate with the second of the product descriptions has an attribute type equal to that of the personalized product attribute, and an attribute value similar to that of the personalized product attribute;
method 500 further comprises: receiving a series of changes to the search parameters via the interface of the user device; and in response to each of the series of changes to the search parameters, updating the personalized product ranking, generating the personalized user interface, and displaying the personalized user interface on the user device;
method 500 further comprises: receiving a series of changes to the attribute ranking via the interface of the user device; and in response to each of the series of changes to the attribute ranking, updating the personalized product ranking, generating the personalized user interface, and displaying the personalized user interface on the user device;
method 500 further comprises: receiving a series of personalized product attributes via the interface of the user device; and in response to each of the series of personalized product attributes, updating the personalized product ranking, generating the personalized user interface, and displaying the personalized user interface on the user device;
method 500 further comprises: receiving a series of user location data via a location module of the user device; and in response to receiving each of the series of user location data, updating the personalized product ranking based on the received user location data, generating the personalized user interface, and displaying the personalized user interface on the user device;
the user device comprises one of: a smartphone, and a wearable device; and
the product descriptions comprise product descriptions for consumable bioactive products.

### Some Embodiments

Some embodiments of the present invention may comprise a method for dynamically customizing a user interface, wherein the dynamic customization of the user interface may be based at least in part on a one or more of:
one or more product descriptions, wherein each of the product descriptions may comprise one or more of: a product name, a product photo, an audio description, a textual description, and the like;
one or more product attributes, wherein each of the product attributes corresponds to one of the product descriptions and has an attribute type and an attribute value. The attribute types may include one or more of: a product availability, a product location; a product price; a product review; a category, a subcategory, a usage method, one or more ingredients; one or more production characteristics, one or more product classifications, one or more user sensations, one or more effects; and the like. The attribute value of each product attribute may be any valid value of the corresponding attribute type;
one or more search parameters, wherein each of the search parameters corresponds to one of the attribute types and has a search value;
one or more attribute scores, wherein each of the attribute scores corresponds to an attribute type and has a score value;
an attribute ranking comprising a ranked list of two or more attribute types; and one or more attribute weights, wherein each of the attribute weights corresponds to an attribute type and has an attribute weighting.

One or more embodiments of the present invention may generate an initial product ranking and a personalized product ranking, based at least in part on product data comprising a plurality of product descriptions and a plurality of product attributes, one or more search parameters, and an attribute ranking. For example, where the product data comprises two products (e.g. Products A and B), each with four attributes (e.g. Consumption Method, Flavor(s), Effect(s), and Sugar Content), example calculations of a initial product ranking and a personalized product ranking for the two products is as follows in tables 1 to 4:

TABLE 1
Product A initial product ranking:

| | | | Product A | |
|---|---|---|---|---|
| Attribute | | Attribute | Attribute | Attribute- |
| Type | Attribute Range | Search Value | Value | Search Score |
| Consumption | Ingest, Topical | Ingest | Ingest | 100 |
| Method | | | | |
| Flavor(s) | Sour, Sweet, Citrus, Tart | Sour, Citrus | Sour, Citrus | 102 |
| Effect(s) | Physically Relaxing, | Mentally | Physically | 0 |
| | Physically Rejuvenating, | Calming | Relaxing | |
| | Mentally Calming, | | | |
| | Mentally Stimulating | | | |
| Sugar | Any number | <10 g per | 7 g per | 100 |
| Content | | serving | serving | |

Product A initial product ranking total score: 302

TABLE 2
Product B initial product ranking:

| | | | Product B | Attribute- |
|---|---|---|---|---|
| Attribute | | Attribute | Attribute | Search |
| Type | Attribute Range | Search Value | Value | Score |
| Consumption | Ingest, Topical | Ingest | Ingest | 100 |
| Method | | | | |
| Flavor(s) | Sour, Sweet, Citrus, Tart | Sour, Citrus | Tart | 0 |
| Effect(s) | Physically Relaxing, | Mentally | Mentally | 101 |
| | Physically Rejuvenating, | Calming | Calming | |
| | Mentally Calming, | | | |
| | Mentally Stimulating | | | |
| Sugar | Any number | <10 g per | 9 g per | 100 |
| Content | | serving | serving | |

Product B initial product ranking total score: 301

TABLE 3
Product A personalized product ranking:

| | | | | | | Weighted |
|---|---|---|---|---|---|---|
| | | Attribute | Attribute | Product | Attribute- | Attribute- |
| Attribute | Attribute | Search | Rank | Attribute | Search | Search |
| Type | Range | Value | (weight) | Value | Score | Score |
| Consumption | Ingest, Topical | Ingest | 1 (5) | Ingest | 100 | 500 |
| Method | | | | | | |
| Flavor(s) | Sour, Sweet, | Sour, | 3 (3) | Sour, | 102 | 306 |
| | Citrus, Tart | Citrus | | Citrus | | |
| Effect(s) | Physically | Mentally | 2 (4) | Physically | 0 | 0 |
| | Relaxing, | Calming | | Relaxing | | |
| | Physically | | | | | |
| | Rejuvenating, | | | | | |
| | Mentally | | | | | |
| | Calming, | | | | | |
| | Mentally | | | | | |
| | Stimulating | | | | | |
| Sugar Content | Any number | <10 g | 4 (2) | 7 g per | 100 | 200 |
| | | per | | serving | | |
| | | serving | | | | |

Product A personalized product ranking total score: 1,006

TABLE 4
Product B personalized product ranking:

| | | | | | | Weighted |
|---|---|---|---|---|---|---|
| | | Attribute | | Product | Attribute- | Attribute- |
| Attribute | | Search | Attribute | Attribute | Search | Search |
| Type | Attribute Range | Value | Rank | Value | Score | Score |
| Consumption | Ingest, Topical | Ingest | 1 (5) | Ingest | 100 | 500 |
| Method | | | | | | |
| Flavor(s) | Sour, Sweet, | Sour, | 3 (3) | Tart | 0 | 0 |
| | Citrus, Tart | Citrus | | | | |
| Effect(s) | Physically | Mentally | 2 (4) | Mentally | 101 | 404 |
| | Relaxing, | Calming | | Calming | | |
| | Physically | | | | | |
| | Rejuvenating, | | | | | |
| | Mentally | | | | | |
| | Calming, | | | | | |
| | Mentally | | | | | |
| | Stimulating | | | | | |
| Sugar Content | Any number | <10 g | 4 (2) | 9 g per | 100 | 200 |
| | | per | | serving | | |
| | | serving | | | | |

Product B personalized product ranking total score: 1,104

As illustrated in the example above, an attribute ranking may affect which of products A and B are ranked higher. The initial ranking of product A is higher than that of product B because product A more closely matches the flavor search criteria than product B, and even though product B matches the effect search criteria, product A is ranked higher because more points are attributed to the higher matching of the flavor search criteria.

Once the rankings are added, and the weights are applied, the total score of product B exceeds that of product A, because the effect attribute is ranked higher than the flavor attribute.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.
Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.
Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.
Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.
For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.
In addition, while elements are at times shown as being performed sequentially, they may instead be performed simultaneously or in different sequences. It is therefore intended that the following claims are interpreted to include all such variations as are within their intended scope.
Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.
The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.
In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.
Some embodiments and/or features of the present invention may comprise or reference artificial intelligence (AI), including machine learning (ML). Where a feature of the present invention is described as comprising a machine learning algorithm, unless otherwise stated, the machine learning algorithm may comprise one or more of:
an untrained machine learning model;
a trained machine learning model, for example a training convolutional neural network (CNN), recurrent neural network (RNN), and the like;
a lookup table; and
a software algorithm.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method of displaying a dynamically customized user interface for a plurality of products on a computing device, the method comprising:
receiving product data comprising a plurality of product descriptions and a plurality of product attributes, wherein each of the product attributes is associated with one of the product descriptions and has an attribute type of a plurality of attribute types and an attribute value;
receiving search parameters via an interface of the computing device,
wherein each of the search parameters corresponds one of the attribute types and has a search value;
generating an initial product ranking of one or more of the product descriptions based on the product attributes and the product search parameters;
generating an initial user interface comprising the initial product ranking;
displaying the initial user interface on the computing device;
receiving an attribute ranking via the interface of the computing device, wherein the attribute ranking comprises a ranked list of at least two of the plurality of attribute types;
receiving a personalized product attribute via the interface of the computing device, wherein the personalized product attribute is associated with a one of the product descriptions and has an attribute value and an attribute type equal to an attribute type of a one of the product attributes also associated with the one of the product descriptions;
replacing the attribute value of the one of the product attributes with the attribute value of the personalized product attribute;
generating a personalized product ranking of one or more of the product descriptions based on the product attributes having the personalized product attribute, the product search parameters, and the attribute ranking;
generating a personalized user interface comprising the personalized product ranking; and
displaying the personalized user interface on the computing device.

2. The method according to claim 1, wherein:
the product descriptions comprise a first product description and a second product description;
the product attributes comprise a first set of product attributes associated with the first product description, and a second set of product attributes associated with the second product description, wherein the first set of product attributes and the second set of product attributes each comprise a plurality of common product attributes with corresponding attribute types;
the search parameters correspond to the attribute types of the common product attributes;
the attribute ranking comprises a ranking of the common product attributes; and
generating the personalized product ranking comprises generating a product-attribute score for each of the common product attributes for each of the first and second product descriptions, scaling each product-attribute score by the rank of the associated common product attribute within the attribute ranking, and generating the personalized product ranking based on each scaled product-attribute score.

3. The method according to claim 1, wherein the attribute types comprise a mandatory attribute type and the search parameters comprise a mandatory search parameter corresponding to the mandatory attribute type, and the personalized product ranking comprises only product descriptions with an associated product attribute having an attribute type equal to the mandatory attribute type and an attribute value meeting the search value of the mandatory search parameter.

4. The method according to claim 1, wherein each of the attribute types is one of:
a binary attribute, and the associated attribute value is either “true” or “false”;
a range attribute, and the associated attribute value is any value within a range;
an integer attribute, and the associated attribute value is any integer between a minimum value and a maximum value;
a single-member attribute, and the associated attribute value is one of a set of two or more members; and
a multi-member attribute, and the associated attribute value is one or more of a set of two or more members.

5. The method according to claim 4, wherein generating the personalized product ranking comprises one or more of:
for a product attribute with the range attribute type, scaling a first product-attribute score higher than a second product-attribute score, wherein a first distance between the first attribute value and the search value is less than a second distance between the second attribute value and the search value;
for a product attribute with the integer attribute type, scaling a first product-attribute score higher than a second product-attribute score, wherein a first distance between the first attribute value and the search value is less than a second distance between the second attribute value and the search value; and
for a product attribute with the multi-member attribute type, scaling a first product-attribute score higher than a second product-attribute score, wherein the first attribute value has more members in common with the search value than the second attribute value.

6. The method according to claim 1, wherein the computing device comprises a mobile device, and the method further comprises receiving user location data via a location module of the mobile device, and generating the personalized product ranking comprises generating the personalized product ranking based on the user location data.

7. The method according to claim 1, further comprising:
receiving a personalized product attribute via the interface of the computing device, wherein the personalized product attribute is associated with a one of the product descriptions; and
wherein the product attributes comprise customer review data, and
generating the personalized product ranking comprises generating the personalized product ranking based on the personalized product attribute and the customer review data.

8. The method according to claim 7, wherein generating the personalized product ranking based on the personalized product attribute and the customer review data comprises excluding the one of the product descriptions from the personalized product ranking.

9. The method according to claim 7, wherein generating the personalized product ranking based on the personalized product attribute and the customer review data comprises excluding a second of the product descriptions from the personalized product ranking, wherein a product attribute associate with the second of the product descriptions has an attribute type equal to that of the personalized product attribute, and an attribute value similar to that of the personalized product attribute.

10. The method according to claim 1, further comprising:
receiving a series of changes to the search parameters via the interface of the computing device; and
in response to each of the series of changes to the search parameters,
updating the personalized product ranking, generating the personalized user interface, and displaying the personalized user interface on the computing device.

11. The method according to claim 1, further comprising:
receiving a series of changes to the attribute ranking via the interface of the computing device; and
in response to each of the series of changes to the attribute ranking, updating the personalized product ranking, generating the personalized user interface, and displaying the personalized user interface on the computing device.

12. The method according to claim 1, further comprising:
receiving a series of personalized product attributes via the interface of the computing device; and
in response to each of the series of personalized product attributes, updating the personalized product ranking, generating the personalized user interface, and displaying the personalized user interface on the computing device.

13. The method according to claim 1, wherein the computing device comprises a mobile device, and the method further comprises:
receiving a series of user location data via a location module of the mobile device; and
in response to receiving each of the series of user location data, updating the personalized product ranking based on the received user location data, generating the personalized user interface, and displaying the personalized user interface on the mobile device.

14. The method according to claim 1, wherein the computing device comprises one of: a smartphone, and a wearable device.

15. The method according to claim 1, wherein the product descriptions comprise product descriptions for consumable bioactive products.

16. A system for displaying a dynamically customized user interface for a plurality of products on a computing device, the system comprising a computing device configured to:
receive product data comprising a plurality of product descriptions and a plurality of product attributes, wherein each of the product attributes is associated with one of the product descriptions and has an attribute type of a plurality of attribute types and an attribute value;
receive search parameters via an interface of the computing device, wherein each of the search parameters corresponds one of the attribute types and has a search value;
generate an initial product ranking of one or more of the product descriptions based on the product attributes and the product search parameters;
generate an initial user interface comprising the initial product ranking;
display the initial user interface;
receive an attribute ranking via the interface of the computing device, wherein the attribute ranking comprises a ranked list of at least two of the plurality of attribute types;
receive a personalized product attribute via the interface of the computing device, wherein the personalized product attribute is associated with a one of the product descriptions and has an attribute value and an attribute type equal to an attribute type of a one of the product attributes also associated with the one of the product descriptions; and
replace the attribute value of the one of the product attributes with the attribute value of the personalized product attribute;
generate a personalized product ranking of one or more of the product descriptions based on the product attributes having the personalized product attribute, the product search parameters, and the attribute ranking;
generate a personalized user interface comprising the personalized product ranking; and
display the personalized user interface on the computing device.

17. The system according to claim 16, wherein:
the product descriptions comprise a first product description and a second product description;
the product attributes comprise a first set of product attributes associated with the first product description, and a second set of product attributes associated with the second product description, wherein the first set of product attributes and the second set of product attributes each comprise a plurality of common product attributes with corresponding attribute types;
the search parameters correspond to the attribute types of the common product attributes;
the attribute ranking comprises a ranking of the common product attributes; and
generating the personalized product ranking comprises generating a product-attribute score for each of the common product attributes for each of the first and second product descriptions, scaling each product-attribute score by the rank of the associated common product attribute within the attribute ranking, and generating the personalized product ranking based on each scaled product-attribute score.

18. The system according to claim 16, wherein the attribute types comprise a mandatory attribute type and the search parameters comprise a mandatory search parameter corresponding to the mandatory attribute type, and the personalized product ranking comprises only product descriptions with an associated product attribute having an attribute type equal to the mandatory attribute type and an attribute value meeting the search value of the mandatory search parameter.

19. The system according to claim 16, wherein each of the attribute types is one of:
a binary attribute, and the associated attribute value is either “true” or “false”;
a range attribute, and the associated attribute value is any value within a range;
an integer attribute, and the associated attribute value is any integer between a minimum value and a maximum value;
a single-member attribute, and the associated attribute value is one of a set of two or more members; and
a multi-member attribute, and the associated attribute value is one or more of a set of two or more members.

20. The system according to claim 19, wherein generating the personalized product ranking comprises one or more of:
for a product attribute with the range attribute type, scaling a first product-attribute score higher than a second product-attribute score, wherein a first distance between the first attribute value and the search value is less than a second distance between the second attribute value and the search value;
for a product attribute with the integer attribute type, scaling a first product-attribute score higher than a second product-attribute score, wherein a first distance between the first attribute value and the search value is less than a second distance between the second attribute value and the search value; and
for a product attribute with the multi-member attribute type, scaling a first product-attribute score higher than a second product-attribute score, wherein the first attribute value has more members in common with the search value than the second attribute value.
